(19) United States
(12) Patent Application Publication
(10) Pub. No.: US 2013/0239317 A1
(43) Pub. Date: Sep. 19, 2013

(54) Oscillating Shower Assembly

(71) Applicant: Silas Saunders, Pinecrest, FL (US)

(72) Inventor: Silas Saunders, Pinecrest, FL (US)

(21) Appl. No.: 13/420,537

(22) Filed: Mar. 14, 2012

(51) Int. Cl. A47K 3/28

(52) U.S. Cl. 4/601

(57) ABSTRACT

An assembly including multiple shower heads affixed to a common manifold. This assembly includes a first shower head having a full body coverage oscillating motion, and a second shower head of traditional design and operation. Each of the first shower head and the second shower head are mounted on a common manifold, which in turn is connected to a water supply located within the shower. The manifold is further provided with valves for diverting water to one or the other shower head; and, for the dispensing of liquid soap from a soap dispenser, which is also connected to the said manifold.

### BACKGROUND OF THE INVENTION

1. Field of the Invention

This invention relates to a device. More specifically this invention is directed to a shower assembly including multiple shower heads affixed to a common manifold. This assembly includes a first shower head having an oscillating motion and a second shower head of traditional design. Each of the first shower head and the second shower head are mounted to a common manifold which in turn is connected to a water supply within the shower.

2. Description of the Prior Art

Traditional shower designs contemplate a single source of water, located at or near the top of the shower and a shower head, for distribution of the water onto a limited area of an individual's body. Typically, the shower head can be manually adjusted within a limited range of fixed positions, and/or the shower head provide for some modulation of water discharge, either by focusing or diffusing the spray pattern, and/or by creating a pulsating discharge of water. In any event, the shower/rinse is a “drip down” process. In the more elaborate shower designs, the shower is constructed of multiple nozzles within the walls of the shower stall, to bathe the individual over most of his or her body. This latter configuration does not readily lend itself to modification of existing showers.

The prior art is replete with patents relating to shower head designs having adjustable shower heads for modulation of the pattern, rate of flow and/or the pulsation of the flow of the water. However, none of these designs provide for the full oscillation of shower water to shower and rinse an individual. Additionally, none of the traditional shower assemblies have the capability to provide a full body shower massage.

U.S. Pat. No. 4,254,914, (to Shames et al, issued Mar. 10, 1981) is representative of this category of prior art. According to the Shames et at patent, his invention relates to a shower head in which the shower head includes a diverter shaft, which can be selectively positioned, by the user, to provide a regular spray or a pulsating spray. The control for selecting which of the sprays will be discharged is implemented through the use of a diverter body that has a radial control sleeve defined therein, into which inflow water enters, and impinges upon the diverter shaft. The diverter shaft, which is pivotally mounted in said control sleeve, directs the inflow water into one of two alternate flow paths, which are specific for and in fluid communication with the respective apertures for the two different sprays.

More recently, one shower design has included a shower head having an oscillating feature which is a “sweep pattern” motion, moving side to side over the upper body.

U.S. Pat. No. 6,908,047, (to Saunders et al, issued Jun. 21, 2005) is representative of this category of prior art. According to the Saunders et al, his invention involves and oscillating shower sprayer. The discharge of water through the shower head is modulated by a connectable turbine system, in which the axis of rotation the turbine is collinear with an axis of flow from the water source. A series of cam are coupled with the turbine, which engage a series of cam followers within the shower head. As the turbine driven cams rotate, the cam followers in the shower head cause the shower head to oscillate. The “sweep pattern” motion of the shower head is from side to side on the upper part of the users' body. The Saunders et al, invention includes the inclusion of multiple discharge arrays within a single integrated shower head.

In each of the foregoing prior art devices, the shower head is limited to single shower head, wherein the water flowing there from is distributed within the shower to only a limited portion of the body, based on the array of holes within the shower head, and/or the shape of the shower head (e.g. oval shower head, elongated shower head, etc.). Thus, the choices available to the user are limited and restricted to a spray pattern which does not selectively distribute the water within the shower and/or fails to provide a spray pattern to cover the entire body of the user.

Accordingly, there continues to exist a need for an oscillating shower assembly which facilitates the use of any number of shower heads and modulations, and provides a full body spray pattern.

### OBJECTS OF THE INVENTION

It is the object of this invention to remedy the above as well as the related deficiencies in the prior art.

More specifically, it is the principle object of this invention to an assembly having an oscillating showerhead. A traditional shower accessory and liquid soap dispenser are also essential parts of the assembly. All shower assembly parts are mounted on a common manifold which in turn is connected to a single water inlet within the shower stall.

It is another object of this invention to an assembly having multiple shower heads which includes a manifold that can be readily attached to a single water inlet, and, manually configured to direct water from said water inlet to either the oscillating shower head or to the other fixed traditional showerhead.

It is still another object of this invention to an assembly having multiple shower heads that can be readily adapted to a traditional shower stall equipped with a single water inlet, mainly an oscillating shower assembly which can distribute the water over the users' entire body.

It is still yet another object of this invention to an assembly having multiple shower heads that can be readily adapted to a traditional shower stall equipped with a single water inlet. Additionally, the shower assembly is inexpensive to manufacture, does not require maintenance, and is easy to operate.

### SUMMARY OF INVENTION

The above and related objects are achieved by providing an assembly having multiple shower heads, which includes a first shower head having an oscillating motion, and a second shower head of traditional design and operation. Each of the first shower head and the second shower head are mounted on a common manifold, which in turn is connected to a water supply located within the shower. The traditional shower head can be similar to the typical shower head design found within the shower.

In the preferred embodiments of this invention, the shower head assembly includes a manifold designed/equipped to accept multiple shower heads, and to attach to a water supply within the shower. More specifically, the manifold includes means for mechanically coupling, (e.g. screw threads), for engagement with a complimentary coupling on the shower head, and means, (e.g. valve), for switching/diverting the flow of water, within the manifold, from one shower head to the other, while showering.

The oscillating shower head is also capable of mechanically coupling to the manifold in essentially the same manner as herein described for the shower head of traditional design. The relative location of each shower head on the manifold is not critical. The oscillating shower head is integrated with and powered by a rotary motion drive turbine which is driven by the water pressure from the water supply within the shower stall. The rotary motion drive turbine including a rotating shaft, which is preferably gear driven, and an array of drive gears capable of transfer of rotary motion from the shaft of the rotary motion drive turbine to the oscillating shower head.

The range of movement of the oscillating shower head, in either one direction or the other, is controlled by a pair of mechanical/limiting stops which come in contact with a stem attached to the array of gears in the rotary motion drive housing unit. These stops are manually set to define a range of motion of the oscillating shower head. This rotary motion drive turbine, drive shaft and array of drive gear are herein also collectively referred to as the “intermittent motion ensemble.”

Within the context of this invention, the phrase “intermittent motion ensemble” is also preferably inclusive of an external collar, which is physically coupled to, and integrated with, the rotary motion drive turbine, proximate to the water inlet of the rotary drive turbine shaft. This collar with mechanical/limiting stops attached is used to define the outer limits of the range of motion of the oscillating shower head. The rotary drive unit converts the water (hydraulic) pressure to kinetic energy, which causes the shower head to rotate in one direction or the other. More specifically, the hydraulic pressure of the water supply impinges upon a turbine within the drive, which in turn rotates a shaft that drives the gear array, to effect movement of the shower head. The gear array includes a shifter or reversing means, which translates the rotary motion in one direction or the other, depending upon the relative position of the stops on the rotary motion drive turbine.

As above noted this reversing means has limits or stops which can be set for restricting the clockwise and counter-clockwise movement of the shower head. The range of motion of the oscillating shower head can thus be set to coincide with vertical dimension of the shower stall, or individual bather preferences. Thus, an individual can set the range of motion of the oscillating shower head within the shower to an infinite number of positions in order to experience a unique shower which is more cleansing and therapeutically comforting than any other shower assembly.

In a typical installation, the oscillating shower head can have a range of motion of anywhere from about 45 degrees to about 60 degrees. This range of motion can be increased or decreased by changing the relative position of the stops associated with the intermittent motion ensemble of the rotary motion drive turbine. As the oscillating shower head rotates, for example, in a clockwise direction, the external stops limit the extent of travel in this direction and cause the shifter to change gears and thereby drive the shower head in the counter-clockwise direction.

### BRIEF DESCRIPTION OF THE DRAWING

FIG. 1 depicts a shower head assembly having multiple shower heads mounted to a common manifold and having a liquid soap dispenser.

FIG. 2 depicts the manifold of the shower head assembly of FIG. 1, with each of the shower heads and soap dispenser having been removed.

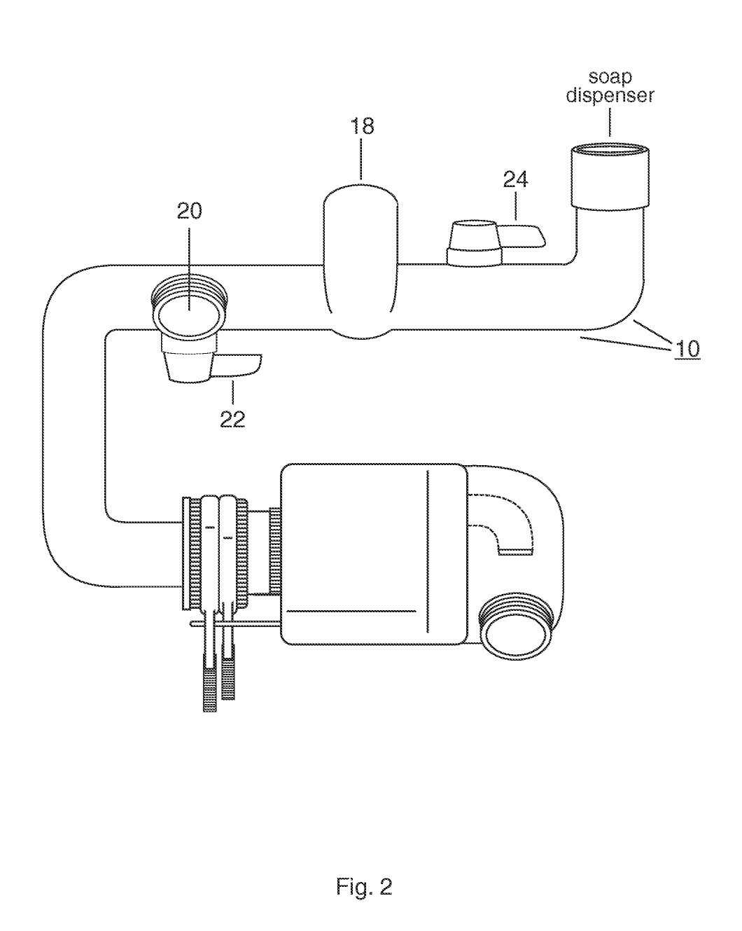

FIG. 3(a) depicts, in isolation, the oscillating shower head and intermittent motion ensemble of FIG. 1.

FIG. 3(b) depicts, in isolation, an alternative embodiment of the oscillating shower head and intermittent motion ensemble of FIG. 1.

### DESCRIPTION OF THE INVENTION INCLUDING PREFERRED EMBODIMENTS

The following Figures depict the invention in a number of different configurations. Where an element appears in more than one such Figure it is assigned a common reference numeral for continuity of expression and ease of understanding.

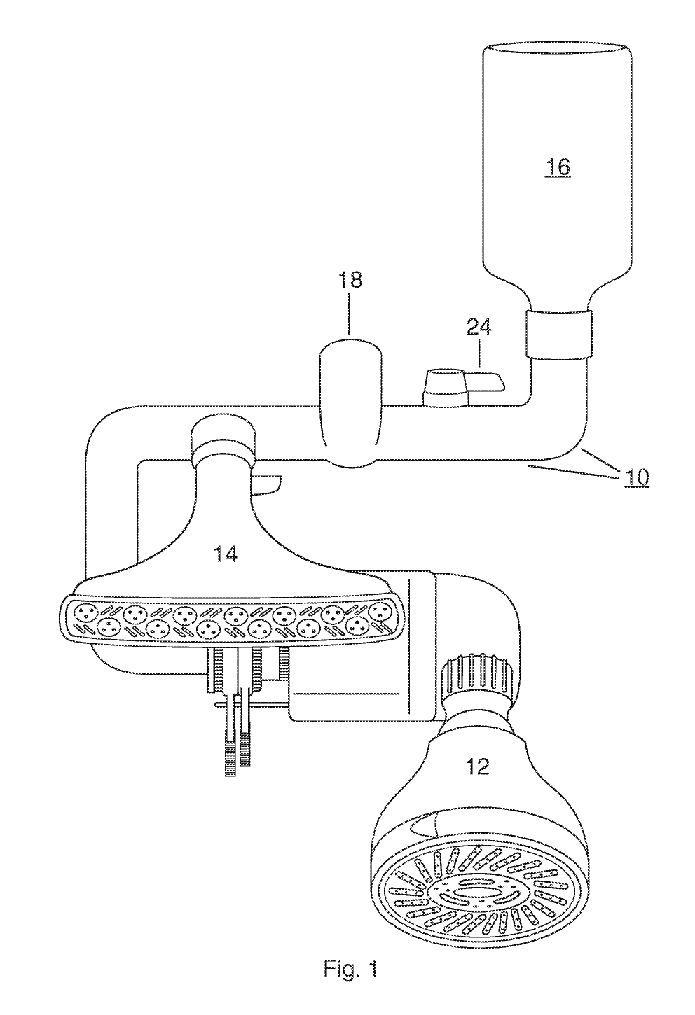

FIG. 1 depicts a preferred embodiment of this invention wherein a manifold (10) is shown having appended thereto multiple shower heads (12, 14) and a soap dispenser (16). The manifold (10) is depicted as having a “U” shape, wherein a soap dispenser (16) is mounted on one branch thereof, and an oscillating shower head (12) mounted on the other branch thereof. Intermediate between the soap dispenser (16) and the oscillating shower head (12), means (18) are provided for mounting the manifold (10) to the water inlet (not shown) within a shower stall; and means (20) for the mounting of a second shower head (14) of traditional design. The manifold (10) is further provided, as shown in FIGS. 1 & 2, with a flow control valve (22), to divert water within the manifold (10) to either one shower head or the other. A second valve (24) is also depicted on the manifold (10) proximate to the soap dispenser (16), for shutting off/modulating of the flow of soap from the dispenser (16) to the manifold (10).

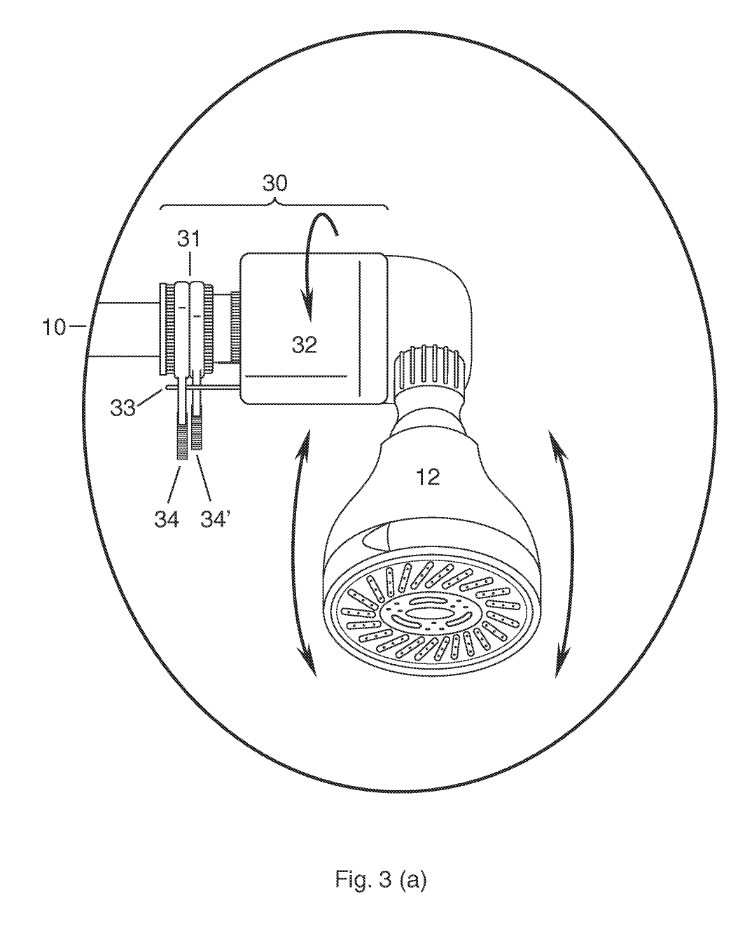

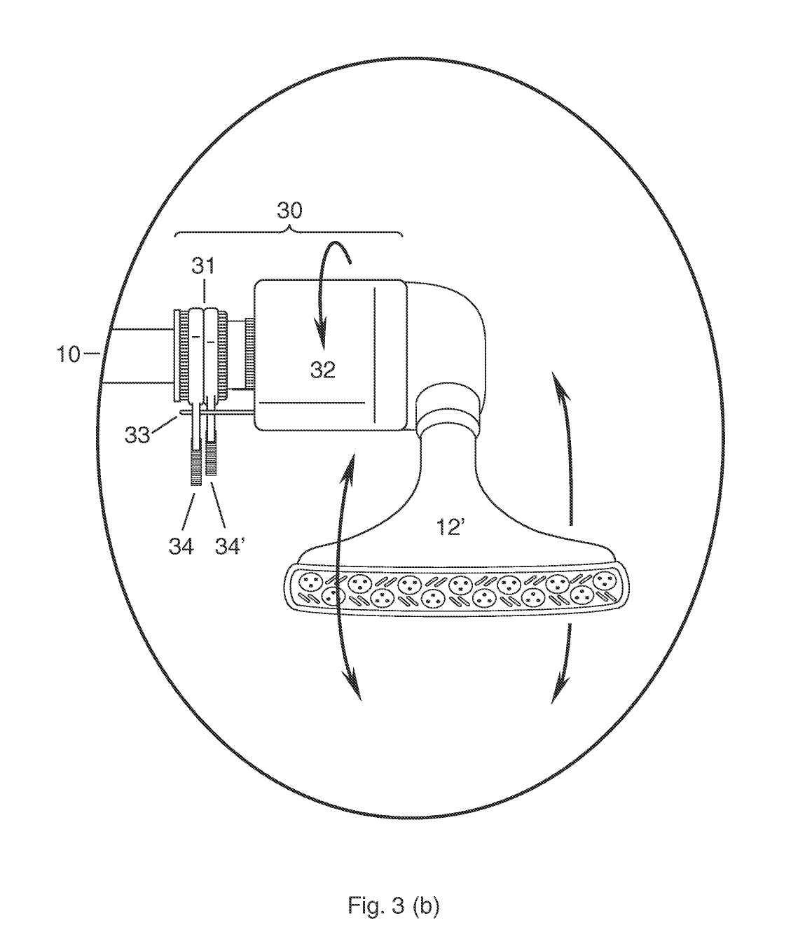

FIGS. 3(a) and 3(b) show, in isolation, the oscillating shower head (12) and intermittent motion ensemble (30) of FIG. 1. FIG. 3(a) depicts an oscillating shower head (12) having a round design; and FIG. 3(b) depicts an oscillating shower (12, 12′) head is connected to the manifold (10) through the intermittent motion ensemble (30). This ensemble (30) includes a collar (31) having a pair of manually adjustable stops (34, 34′), and a rotary motion drive (not shown). This collar (31) integrally connected to rotary motion gear housing (32) and the stops associated therewith (34, 34′), controls the degree of rotation of the rotary motion drive along with the rotary motion drive stem (33) and thus, the relative movement of the rotary shower head. The configuration of the collar (31) stops (34, 34′), and stem (33) as is the rotary motion drive, are similar to the comparable range of motion controls found on oscillating sprinklers used to water lawns and foliage. The design and operation of these components of this intermittent motion ensemble of this invention are depicted in U.S. Pat. No. 5,758,827, (to Le et al), which is herein incorporated by reference in its entirety.

The foregoing description is provided as illustrative of the preferred embodiments of this invention, and, thus, not intended as delineating the scope thereof, which is set forth the Claims which follow.

What is claimed is:

1. In an assembly having a manifold, means for connection of said manifold to a water inlet of a shower stall and an oscillating shower head, the improvement compromises:
A. A manifold with multiple connections for attachment of shower related accessories;
B. Means for connection of a plurality of shower related accessories to said manifold;
C. At least one oscillating shower head adapted for connection to said manifold;
D. A soap dispenser adapted for connection to said manifold;
E. Diverter means for control of flow of water from said water inlet to one or more of said shower related accessories connected to said manifold.

2. The improved assembly of claim 1, wherein an oscillating shower head is mechanically coupled and in fluid communication with said manifold.

3. The improved assembly of claim 2, wherein a shower head of traditional design is mechanically coupled and in fluid communication with said manifold.

4. The improved assembly of claim 3, wherein said oscillating shower head includes an intermittent motion assembly to convert hydraulic pressure to kinetic energy to effect movement of said oscillating shower head to rotate in one direction or another

5. The improved assembly of claim 5, wherein said intermittent motion assembly includes a collar, a rotary shaft, a gear array, and shifter to effect oscillation of said oscillating shower head in one direction or the other.

6. The improved assembly of claim 6, wherein intermittent motion assembly restricts movement of said oscillating shower head range of motion from about 45 degrees to 60 degrees.

7. The improved assembly of claim 1, wherein said diverter means comprises a valve for switching water flow within said manifold from one shower head to another.

8. The improved assembly of claim 8, wherein said shower dispenser includes a valve for modulating the flow of soap from said dispenser into said manifold.
